(19) United States
(12) Patent Application Publication
(10) Pub. No.: US 2007/0184194 A1
(43) Pub. Date: Aug. 9, 2007

(54) TECHNIQUE FOR DEPOSITING METALLIC FILMS USING ION IMPLANTATION SURFACE MODIFICATION FOR CATALYSIS OF ELECTROLESS DEPOSITION

(75) Inventors: Peter D. Nunan, MonteSereno, CA (US); Yuri Erokhin, Newburyport, MA (US)

Correspondence Address: HUNTON & WILLIAMS LLP/VARIAN SEMICONDUCTOR,;EQUIPMENT ASSOCIATES, INC., INTELLECTUAL PROPERTY DEPARTMENT, 1900 K STREET, N.W., SUITE 1200, WASHINGTON, DC, 20006-1109, US

(73) Assignee: Varian Semiconductor Equipment Associates, Gloucester, MA (US)

(21) Appl. No.: 11/672,456

(22) Filed: Feb. 7, 2007

Related U.S. Application Data
(60) Provisional application No. 60/771,591, filed on Feb. 8, 2006.

(51) Int. Cl. B05D 1/32; B05D 1/36

(52) U.S. Cl. 427/272; 427/419.1

(57) ABSTRACT

Techniques for depositing metallic films using ion implantation surface modification for catalysis of electroless deposition are disclosed. In one particular exemplary embodiment, the techniques may be realized as a method for depositing a metallic film. The method may comprise depositing a catalyzing material on a structure, wherein the structure comprises a substrate, a dielectric layer on the substrate, and a resist layer on the dielectric layer, wherein the dielectric layer and the resist layer have one or more openings. The method may also comprise stripping the resist layer. The method may further comprise depositing a metallic film on the catalyzing material in the one or more openings of the structure to fill the one or more openings.

### CROSS-REFERENCE TO RELATED APPLICATIONS

This patent application claims priority to U.S. Provisional Patent Application No. 60/771,591, filed Feb. 8, 2006, which is hereby incorporated by reference herein in its entirety.

### FIELD OF THE DISCLOSURE

The present disclosure relates generally to depositing metallic films and, more particularly, to techniques for depositing metallic films using ion implantation surface modification for catalysis of electroless deposition.

### BACKGROUND OF THE DISCLOSURE

Current semiconductor metallic deposition techniques, such as physical vapor deposition (PVD), chemical vapor deposition (CVD), atomic layer deposition (ALD), and other non-ion implant catalyzed electroless deposition techniques, have limitations. Although these techniques have some benefit and are typically adequate for at depositing thin film layers on relatively flat/level surfaces, these techniques all fail to adequately deposit thin film layers over varying topographies, especially of high aspect ratio (HAR).

For example, PVD and CVD do not adequately fill high aspect ratio features. Also, although ALD is better-suited at filling high aspect ratio vias (holes or openings) in a semiconductor substrate structure, ALD is a relatively slow process. Moreover, thin films deposited by ALD and other similar processes tend to be of a poor quality due to the organic nature of precursors. Further, other non-ion implant catalyzed electroless deposition techniques (e.g., those using Palladium (Pd), such as grafting, colloidal suspensions, and ionized cluster beams (ICB)) tend to have high defectivity and do not adequately fill high aspect ratio structures. Additionally, other processing defects associated with depositing metallic films, such as lift off (e.g., layer detachment), are typically encountered because the strength of metallic film adhesion is insufficient. As a result, these and other traditional deposition techniques fail to adequately deposit metallic films over semiconductor structures, particularly those structures that have variable topographies.

In view of the foregoing, it would be desirable to provide catalyzed electroless deposition techniques which overcome the above-described inadequacies and shortcomings.

### SUMMARY OF THE DISCLOSURE

Techniques for depositing metallic films using ion implantation surface modification for catalysis of electroless deposition are disclosed. In accordance with one particular exemplary embodiment, the techniques may be realized as a method for depositing a metallic film. The method may comprise depositing a catalyzing material on a structure, wherein the structure comprises a substrate, a dielectric layer on the substrate, and a resist layer on the dielectric layer, wherein the dielectric layer and the resist layer have one or more openings. The method may also comprise stripping the resist layer. The method may additionally comprise depositing a metallic film on the catalyzing material in the one or more openings of the structure to fill the one or more openings.

In accordance with other aspects of this particular exemplary embodiment, the catalyzing material modifies at least one surface of the structure for catalyzing electroless deposition of the metallic film.

In accordance with further aspects of this particular exemplary embodiment, the catalyzing material mixes uniformly with the substrate to form a catalyzing layer.

In accordance with additional aspects of this particular exemplary embodiment, the catalyzing material is mixed to a predetermined depth and provides improved metallic film surface adhesion.

In accordance with further aspects of this particular exemplary embodiment, depositing the metallic film comprises a bottom-up fill.

In accordance with another exemplary embodiment, the techniques may be realized as a method for depositing a metallic film. The method may comprise depositing a catalyzing material on a structure, wherein the structure comprises a substrate and a dielectric layer on the substrate. The method may also comprise forming a catalyzing layer on the structure. The method may additionally comprise depositing a metallic film on the catalyzing layer.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIGS. 1A-1D depict a method for depositing a metallic film using an ion implantation surface modification for catalysis of electroless deposition bottom-up fill technique according to an embodiment of the present disclosure.

FIGS. 2A-2C depict a method for depositing a metallic film using an ion implantation surface modification for catalysis of electroless deposition technique according to an embodiment of the present disclosure.

### DETAILED DESCRIPTION OF EXEMPLARY EMBODIMENTS

Ion implantation is a process of depositing chemical species into a substrate by direct bombardment of the substrate with energized ions. In semiconductor fabrication, ion implanters are used primarily for doping processes that alter the type and level of conductivity of target materials. A precise doping profile in an integrated circuit (IC) substrate and its thin-film structure is often crucial for proper IC performance. To achieve a desired doping profile, one or more ion species may be implanted in different doses and at different energy levels. A specification of the ion species, doses, and energies is referred to as an ion implantation recipe.

According to embodiments of the present disclosure, an ion implantation surface modification for the catalysis of electroless deposition may be used to alleviate the limitations of current techniques for filling and depositing metallic films. Because ion implantation is known to be extremely directional, embodiments of the present disclosure directed to ion implantation surface modification for the catalysis of electroless deposition may therefore be advantageously used to modify the surface properties of materials by electronegativity as related to electrochemical potential. By altering the electrochemical potential of surfaces such as SiO₂, Si, organo-silicate glass (OSG) (a carbon-doped glass (CDG)), or other similar materials used in integrated circuit fabrication and implanting near multiple surface monolayers, the “modified surface” may become increasingly susceptible to electrochemical reactions. Such reactions may be favorably used to electrolessly deposit metallic films for purposes of forming interconnecting layers in semiconductor and integrated circuit devices. These interconnecting layers, commonly referred to as back end of the line (BEOL) processing, may be used to wire together active devices such as transistors in an integrated circuit.

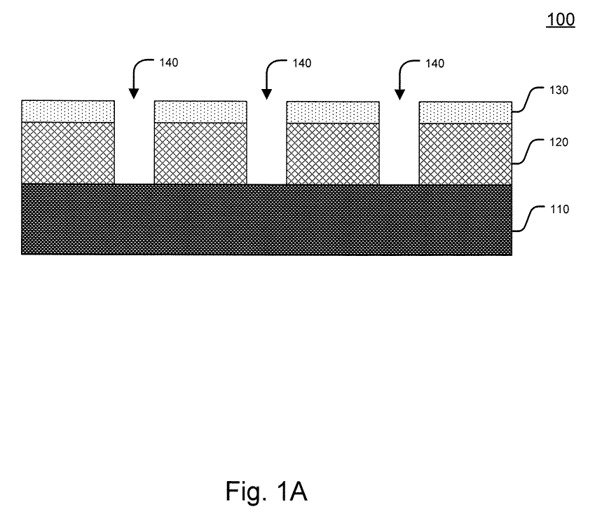

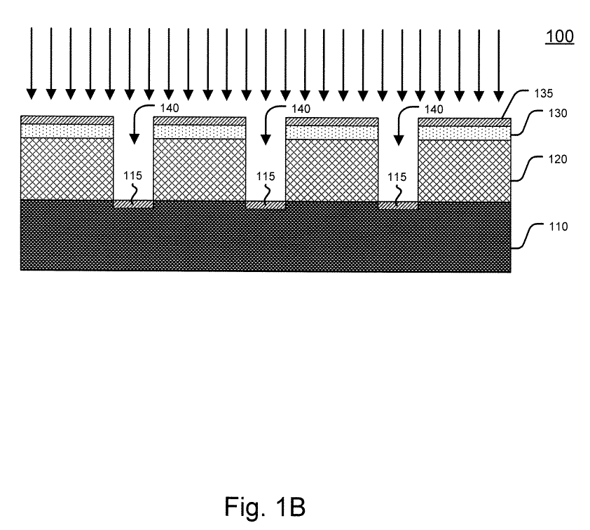

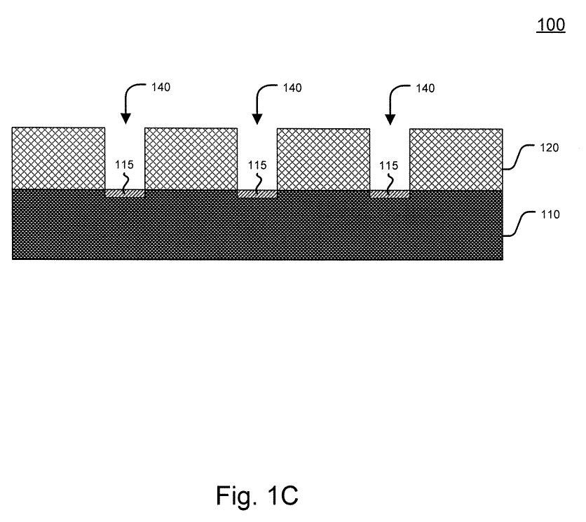

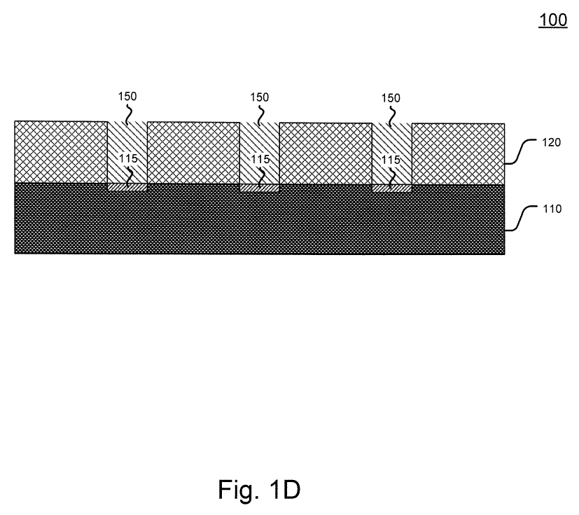

According to one embodiment of the present disclosure, a method for depositing a metallic film using ion implantation surface modification for the catalysis of electroless deposition bottom-up fill technique will be described with reference to FIGS. 1A-1D.

FIG. 1A depicts a structure 100 that includes a substrate 110, a dielectric layer 120 disposed on the substrate 110, and a resist layer 130 disposed on the dielectric layer 120. One or more openings 140 may be patterned in the dielectric layer 120 and the resist later 130 by a variety of fabrication processes, such as etching, masking, photoresist processing, or other similar processes. The substrate 110 may be formed of various materials, such as Si, GaAs, Ge, SiC, InP, GaN, other semiconductor or dielectric materials, or a combination thereof. The dielectric layer 120 may be formed of a variety of low-dielectric materials, such as SiO₂, SiON, boron phosphorus silicate glass (BPSG), carbon-doped glass (CDG), fluorine-doped glass (FDG), aerogels, interlayer dielectrics, or a combination thereof.

Each of the one or more openings 140 in the dielectric layer 120 and the resist layer 130 may have a size (e.g., diameter) and/or a high aperture ratio (HAR) (e.g., depth to diameter) value. For example, in one embodiment of the present disclosure, the diameter of an opening may range from approximately 20 nm to 300 nm and the HAR may range from 1:1 to 30:1. It should be appreciated by one of ordinary skill in the art that these values for diameter and HAR should not be limited to the aforementioned dimensions. Other variations may also be utilized.

Referring to FIGS. 1B-1D, a method is provided for depositing a metallic film 150 on the structure 100 using ion implantation surface modification for the catalysis of electroless deposition in accordance with an embodiment of the present disclosure.

Specifically, FIG. 1B depicts depositing a catalyzing material on the structure 100. The catalyzing material may include palladium (Pd) or other similar catalyzing materials such as ruthenium (Ru), Praseodymium (Pr), platinum (Pt), etc. Depositing the catalyzing material may include a variety of processes, such as ion implantation or bombardment (see arrows in FIG. 1B). Because of the one or more openings 140 in the dielectric layer 120, the catalyzing material may be deposited on the resist layer 130 and on the substrate 110. An ion implant of such catalyzing materials may be particularly advantageous due to its resist capabilities, especially when located at the bottom of the one or more openings 140.

For example, in one embodiment of the present disclosure, the catalyzing material may mix uniformly with the substrate 110 and the resist layer 130 to form respective catalyzing layers 115, 135. Because the catalyzing layer 135 will eventually be removed (see FIG. 1C), the following description will focus on the catalyzing layer 115.

In one embodiment of the present disclosure, the catalyzing layer 115 may be mixed with the substrate 110 to a desired predetermined depth (e.g., approximately 100 Å). While other various predetermined depths may also be utilized, forming the catalyzing layer 115 at the bottom of each of the one or more openings 140 may provide an improved surface adhesion for subsequent metallic film depositions. More specifically, the catalyzing layer 115 may provide a uniform and strong adhesion layer for promoting a beneficial “gluing” feature for subsequent metallic films deposited thereon. Additionally, the catalyzing layer 225 may prevent lift off (e.g., layer detachment) and other processing defects associated with depositing metallic films.

Referring to FIG. 1C, the resist layer 130 and the catalyzing layer 135 may be removed or stripped from the structure 100. Removal or stripping may be achieved by several techniques, including oxygen plasma stripping, RCA cleaning, piranha cleaning, using hot phosphoric acid to remove Si₃N₄, or other similar process. Because ion implantation provides excellent angle control, removing or stripping the resist layer 130 and the catalyzing layer 135 from the structure 100 may leave catalyzed surfaces only in the bottom of the one or more openings 140 so as to provide improved filling of HAR structures.

FIG. 1D depicts a metallic film 150 deposited in the one or more openings 140 of the structure 100. In one embodiment, depositing the metallic film 150 may include a bottom-up fill or electroless deposition of the metallic film 150 to fill the one or more openings 140 (or HAR structures) of the structure 100. The metallic film 150 may be formed of a variety of metals, such as Cu, Ni, CoWP, or other conductive materials useful in forming interconnecting layers. As a result, once the metallic film 150 is deposited, a strong adhesion of the deposited metallic film 150 to the substrate 110 and a complete filling of the one or more openings 140 in the topographical structure 100 may be achieved. Since only the bottom surfaces 115 of the one or more openings 140 are “catalyzed” (and not the side walls of the one or more openings 140 in the dielectric layer 120), deposition may occur on the bottom (rather than on the side walls) to completely fill the one or more openings 140. In other words, if the side walls of the one or more openings 140 were also “catalyzed,” the deposited metallic film 150 may have a greater tendency to adhere to the side walls, leaving gaps or unfilled areas in the one or more openings 140, and therefore not adequately filling the one or more openings 140 (or HAR structures) of the structure 100.

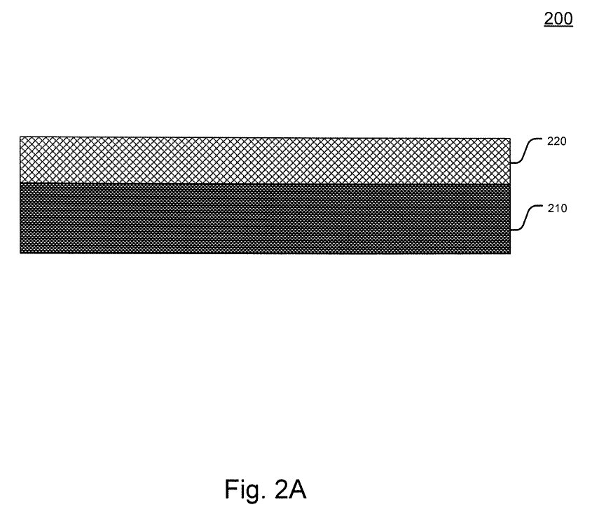

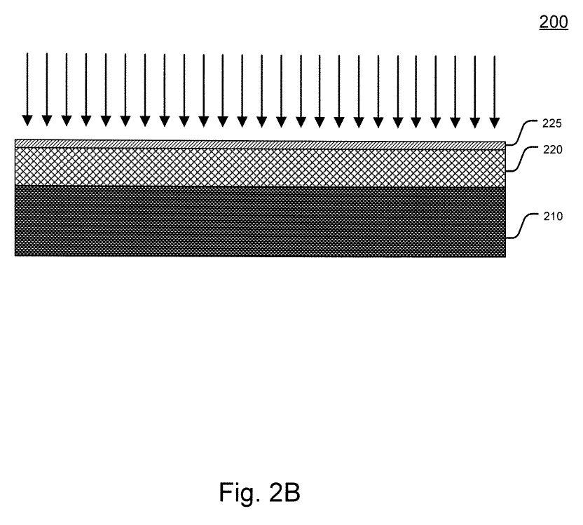

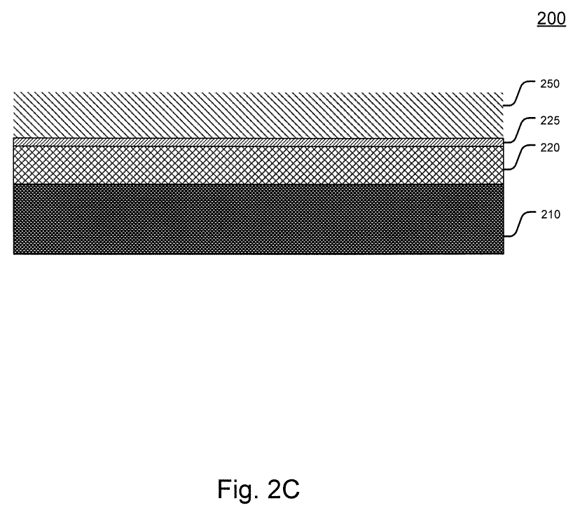

According to another embodiment of the present disclosure, another method for depositing a metallic film using an ion implantation surface modification for catalysis of electroless deposition technique will be described with reference to FIGS. 2A-2C.

FIG. 2A depicts a structure 200 that includes a substrate 210 and a dielectric layer 220 disposed on the substrate 210. Similar to structure 100 of FIGS. 1A-1D, the substrate 210 may be formed of various materials, such as Si, GaAs, Ge, SiC, InP, GaN, other semiconductor or dielectric materials, or a combination thereof. The dielectric layer 120 may also be formed of a variety of low-dielectric materials, such as SiO₂, SiON, boron phosphorus silicate glass (BPSG), carbon-doped glass (CDG), fluorine-doped glass (FDG), aerogels, interlayer dielectrics, or a combination thereof.

However, unlike structure 100 of FIGS. 1A-1D, structure 200 does not include a resist layer or any openings (including HAR structures) patterned in the dielectric layer 220. As a result, metallic film deposition may be achieved directly on the dielectric layer 220.

Referring to FIGS. 2B-2C, a method is provided for depositing a metallic film 250 on the structure 200 using ion implantation surface modification for catalysis of electroless deposition in accordance with an embodiment of the present disclosure.

Specifically, FIG. 2B depicts depositing a catalyzing material on the structure 200. The catalyzing material may include palladium (Pd) or other similar catalyzing materials such as ruthenium (Ru), Praseodymium (Pr), platinum (Pt), etc. Depositing the catalyzing material may include a variety of processes, such as ion implantation or bombardment (see arrows in FIG. 2B). Because the dielectric layer 220 covers the substrate 210, and is therefore exposed to ion implantation and bombardment, the catalyzing material may be deposited directly on the dielectric layer 220.

In one embodiment of the present disclosure, the catalyzing material may mix uniformly with the dielectric layer 220 to form a catalyzing layer 225. In another embodiment, the catalyzing layer 225 may be mixed with the dielectric layer 220 to a desired predetermined depth (e.g., approximately 100 Å). While other various depths may also be utilized, forming the catalyzing layer 225 on the dielectric layer 220 may provide an improved surface adhesion for subsequent metallic film depositions. More specifically, the catalyzing layer 225 may provide a uniform and strong adhesion layer for promoting a beneficial “gluing” feature for subsequent metallic films deposited thereon. Additionally, the catalyzing layer 225 may prevent lift off (e.g., layer detachment) and other processing defects associated with depositing metallic films.

FIG. 2C depicts a metallic film 250 deposited on the structure 200. In one embodiment, depositing the metallic film 250 may include an electroless deposition of the metallic film 250 to cover the catalyzing layer 225 formed on the dielectric layer 220. The metallic film 250 may be formed of a variety of metals, such as Cu, Ni, CoWP, or other conductive materials useful in forming interconnecting layers. As a result, once the metallic film 250 is deposited, a strong adhesion of the deposited metallic film 250 to the substantially planar structure 200 may be achieved.

It should be appreciated that, while embodiments of the present disclosure are directed to semiconductor and integrated circuit manufacturing processes, other implementations may be provided as well. For example, the improved metallic deposition techniques of the present disclosure may be used for depositing metallic films in solar cells wiring, three-dimensional integrated circuit (IC) via filling, and other similar applications and processes.

In addition to improving depositing metallic films over varying topographies (e.g., HAR structures) and reducing processing defects (e.g., lift off), a technique for depositing metals using an ion implantation surface modification for catalysis of electroless deposition technique may have further advantages. For example, greater efficiency in manufacturing and processing semiconductors and integrated circuits may be achieved because excessive time and costs in manufacturing due to ineffective, inefficient, and redundant steps associated with traditional deposition techniques may be reduced and/or eliminated using the improved metallic deposition techniques of the present disclosure.

Thus, embodiments of the present disclosure may provide enhanced deposition of metallic films on silicon and insulators over varying topographies with the use of ion implantation to catalyze the surface by expanding the application of ion implantation from traditional uses of doping and etch rate modification.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure can be beneficially implemented in any number of environments for any number of purposes. Accordingly, the claims set forth below should be construed in view of the full breadth and spirit of the present disclosure as described herein.

1. A method for depositing a metallic film, the method comprising:
depositing a catalyzing material on a structure, the structure comprising a substrate, a dielectric layer on the substrate, and a resist layer on the dielectric layer, the dielectric layer and the resist layer having one or more openings;
stripping the resist layer; and
depositing a metallic film on the catalyzing material in the one or more openings of the structure to fill the one or more openings.

2. The method of claim 1, wherein the catalyzing material modifies at least one surface of the structure for catalyzing electroless deposition of the metallic film.

3. The method of claim 1, wherein the catalyzing material is deposited on the resist and the substrate.

4. The method of claim 3, wherein the catalyzing material mixes uniformly with the substrate to form a catalyzing layer.

5. The method of claim 4, wherein the catalyzing material is mixed to a predetermined depth.

6. The method of claim 5, wherein the predetermined depth is approximately 100 Å.

7. The method of claim 4, wherein the catalyzing layer provides improved metallic film surface adhesion.

8. The method of claim 1, wherein the catalyzing material comprises at least one of Pd, Ru, Rh, and Pt.

9. The method of claim 1, wherein the substrate is formed of at least one of Si, GaAs, Ge, SiC, InP, and GaN.

10. The method of claim 1, wherein the dielectric layer is formed of a low dielectric material.

11. The method of claim 10, wherein the low dielectric material comprises at least one of SiO₂, SiON, boron phosphorus silicate glass (BPSG), carbon-doped glass (CDG), fluorine-doped glass (FDG), aerogels, or interlayer dielectrics.

12. The method of claim 1, wherein the one or more openings are formed by a patterning process.

13. The method of claim 12, wherein the patterning process comprises at least one of etching, masking, and photoresist processing.

14. The method of claim 1, wherein each of the one or more openings comprises a diameter of approximately 20 nm to 300 nm.

15. The method of claim 1, wherein each of the one or more openings comprises a high aperture ratio (HAR) of approximately 1:1 to 30:1.

16. The method of claim 1, wherein depositing the metallic film comprises a bottom-up fill.

17. The method of claim 1, wherein the metallic film comprises at least one of Cu, Ni, and CoWP.

18. A semiconductor structure formed from the method of claim 1.

19. A method for depositing a metallic film, the method comprising:
depositing a catalyzing material on a structure, the structure comprising a substrate and a dielectric layer on the substrate;
forming a catalyzing layer on the structure; and
depositing a metallic film on the catalyzing layer.

20. The method of claim 19, wherein the catalyzing material modifies at least one surface of the structure for catalyzing electroless deposition of the metallic film.

21. The method of claim 20, wherein the catalyzing layer is formed on the dielectric layer.

22. The method of claim 21, wherein the catalyzing layer comprises catalyzing material mixed uniformly with the dielectric layer.

23. The method of claim 22, wherein the catalyzing material is mixed to a predetermined depth of approximately 100 Å.

24. The method of claim 21, wherein the catalyzing layer provides improved metallic film surface adhesion.

25. The method of claim 19, wherein the catalyzing material comprises at least one of Pd, Ru, Rh, and Pt.

26. The method of claim 19, wherein the substrate is formed of at least one of Si, GaAs, Ge, SiC, InP, and GaN.

27. The method of claim 19, wherein the dielectric layer is formed of a low dielectric material.

28. The method of claim 27, wherein the low dielectric material comprises at least one of SiO₂, SiON, boron phosphorus silicate glass (BPSG), carbon-doped glass (CDG), fluorine-doped glass (FDG), aerogels, or interlayer dielectrics.

29. The method of claim 19, wherein the metallic film comprises at least one of Cu, Ni, and CoWP.

30. A semiconductor structure formed from the method of claim 19.
